(19) United States
(12) Patent Application Publication
(10) Pub. No.: US 2018/0164134 A1
(43) Pub. Date: Jun. 14, 2018

(54) PNEUMATIC SENSOR IN ELECTRONIC CIGARETTE, DEVICE FOR PROCESSING AIRFLOW, AND ELECTRONIC CIGARETTE

(71) Applicant: Nazhiyuan Technology (Tangshan), LLC., Tangshan (CN)

(72) Inventors: Qiang Zhong, Tangshan (CN); Lijia Sun, Tangshan (CN); Haifeng Diao, Tangshan (CN); Tongfu Li, Tangshan (CN); Hao Zhao, Tangshan (CN); Xiaoya Sun, Tangshan (CN); Chi Cheng, Tangshan (CN); Ying Zhao, Tangshan (CN); Xiao Qiu, Tangshan (CN); Lixing Hao, Tangshan (CN)

(73) Assignee: Nazhiyuan Technology (Tangshan), LLC., Tangshan (CN)

(21) Appl. No.: 15/315,165

(22) PCT Filed: Jun. 3, 2016
(86) PCT No.: PCT/CN2016/084679

§ 371 Date: Mar. 2, 2018

(30) Foreign Application Priority Data
Jul. 28, 2015 (CN) 201510452285.7
Oct. 21, 2015 (CN) 201520819518.8

(51) Int. Cl. G01F 1/20; A24F 47/00; H01B 1/08; H01B 5/14

(52) U.S. Cl. CPC G01F 1/20; H01B 5/14; H01B 1/08; A24F 47/002

(57) ABSTRACT

A pneumatic sensor in an electronic cigarette, a device for processing airflow and an electronic cigarette are provided. The pneumatic sensor in the electronic cigarette includes a housing, defining a chamber and provided with a window at a top of the housing, an air inlet at a side wall of the housing, and at least one suction hole at a bottom of the housing, the window, the air inlet, and the suction hole all being communicated with the chamber; a vibrating film unit, disposed inside the housing and provided with a vibrating film capable of vibrating under airflow; and an electrode plate, acting as a signal outputting end of the pneumatic sensor in the electronic cigarette, and the vibrating film has a fixed end fixed to the vibrating film unit and a free end.

### CROSS-REFERENCE TO RELATED APPLICATION

This application claims priorities to and benefits of Chinese Patent Application No. 201510452285.7 and No. 201520819518.8, filed with the State Intellectual Property Office of P. R. China on Jul. 28, 2015 and Oct. 21, 2015, respectively; and titled with “Pneumatic sensor in electronic cigarette, device for processing airflow and electronic cigarette” and “signal processing system and electronic cigarette having the same”, respectively, the entire contents of which are incorporated herein by reference.

### FIELD

The present disclosure relates to the field of a sensor, and particularly to a pneumatic sensor in an electronic cigarette, a device for processing airflow, and an electronic cigarette.

### BACKGROUND

An electronic cigarette, also known as a virtual cigarette, has similar appearance and taste to a traditional cigarette. The electronic cigarette is designed in a way such that smoke can also be generated and sucked therefrom, similar to the traditional cigarette. In addition, spices with a variety of flavors, such as mint, may also be added to some of the electronic cigarettes based on user's personal preference.

With the continuous development of people's living needs, more and more people choose the electronic cigarette instead of the traditional cigarette, because the electronic cigarette does not contain tar, suspended particles and other harmful components contained in the traditional cigarette. Furthermore, some people also use the electronic cigarette for smoking cessation.

However, those existing sensors applied in the electronic cigarette have disadvantages such as: high production costs, a complicated manufacturing process, poor stability in an electrical circuit, higher requirement to a signal processing circuit, and being prone to be falsely triggered due to external vibration.

### SUMMARY

An object of the present disclosure is to provide in embodiments a pneumatic sensor in an electronic cigarette, a device for processing airflow, and an electronic cigarette, so as to solve problems existing in those pneumatic sensors in the related art, for example, high production costs, a complicated manufacturing process, higher requirement to a signal processing circuit, and being prone to be interfered by external vibration.

For achieving the above object, the present disclosure provides in embodiments a pneumatic sensor in an electronic cigarette, including: a housing, defining a chamber and provided with a window at a top of the housing, an air inlet at a side wall of the housing, and at least one suction hole at a bottom of the housing, the window, the air inlet, and the suction hole all being communicated with the chamber; a vibrating film unit, disposed inside the housing and provided with a vibrating film capable of vibrating under airflow; and an electrode plate, acting as a signal outputting end of the pneumatic sensor in the electronic cigarette, wherein the vibrating film has a fixed end fixed to the vibrating film unit and a free end.

For achieving the above object, the present disclosure further provides in embodiments a device for processing airflow, including the pneumatic sensor in the electronic cigarette described above and a signal processing system. The signal processing system includes: a signal preprocessing module connected to a signal outputting end of the pneumatic sensor in the electronic cigarette, and configured to collect an output signal of the pneumatic sensor in the electronic cigarette and acquire a flag signal through comparing the output signal with a preset threshold; and a signal controlling module connected to the signal preprocessing module, and configured to receive the flag signal output from the signal preprocessing module and acquire a work trigging signal through analyzing and processing the flag signal.

For achieving the above object, the present disclosure further provides in embodiments an electronic cigarette, including: the device for processing airflow described above, a rod, an atomizer, and a power device.

The technical solution provided in embodiments of the present disclosure may have the following advantageous effects.

(1) The pneumatic sensor in the electronic cigarette can be manufactured with low costs by a simple process, as the electrode plate and the vibrating film unit can be directly installed in the housing, which is more suitable for industrial production as compared with a manufacturing process in the related art. In addition, the pneumatic sensor in the electronic cigarette has low requirement to a signal processing circuit and is capable of easily distinguishing an electrical signal generated under airflow from that generated under vibration interference through designing the signal processing circuit, thus effectively preventing the false trigger due to the vibration interference and improving the stability of the pneumatic sensor in the electronic cigarette.

(2) The present disclosure further provides in embodiments a device for processing airflow including the pneumatic sensor in the electronic cigarette described above and a signal processing system, which is applied to the electronic cigarette, thereby effectively reducing production costs of the electronic cigarette, simplifying the process for manufacturing the electronic cigarette, effectively preventing the false trigger due to the vibration interference, and improving the stability of the electronic cigarette.

### BRIEF DESCRIPTION OF THE DRAWINGS

Various other advantages and benefits of embodiments of the present disclosure will become apparent to those ordinarily skilled in the art from the following detailed descriptions to preferred embodiments. The figures are merely for illustrating the preferred embodiments, and shall not be construed to limit the present disclosure. The same elements are denoted by the same reference numerals throughout the figures, in which:

FIG. 1 is a schematic diagram showing a structure of a pneumatic sensor in an electronic cigarette in an embodiment of the present disclosure;

FIG. 2 is a schematic diagram showing a housing in FIG. 1;

FIG. 3 is schematic diagram showing a first triboelectric structure of a pneumatic sensor in an electronic cigarette in an embodiment of the present disclosure;

FIG. 4 is schematic diagram showing a second triboelectric structure of a pneumatic sensor in an electronic cigarette in an embodiment of the present disclosure;

FIG. 5 is block diagram showing functions of a signal processing system in a device for processing airflow in an embodiment of the present disclosure;

FIG. 6 is a structural schematic diagram showing an electronic cigarette in an embodiment of the present disclosure.

### DETAILED DESCRIPTION

In the following, the present disclosure will be specifically described through the illustrative embodiments. However, it should be appreciated that, components, structures, and characteristics in an embodiment may also be beneficially incorporated to other embodiments, in the absence of further description.

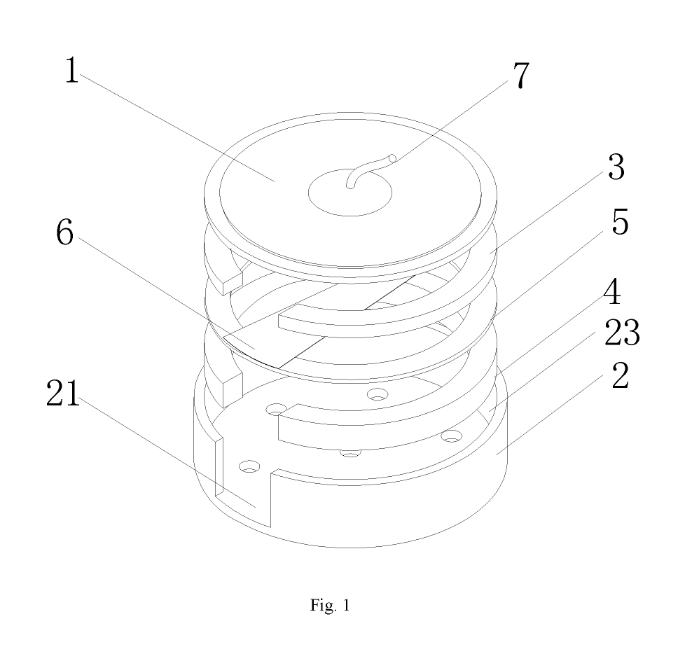

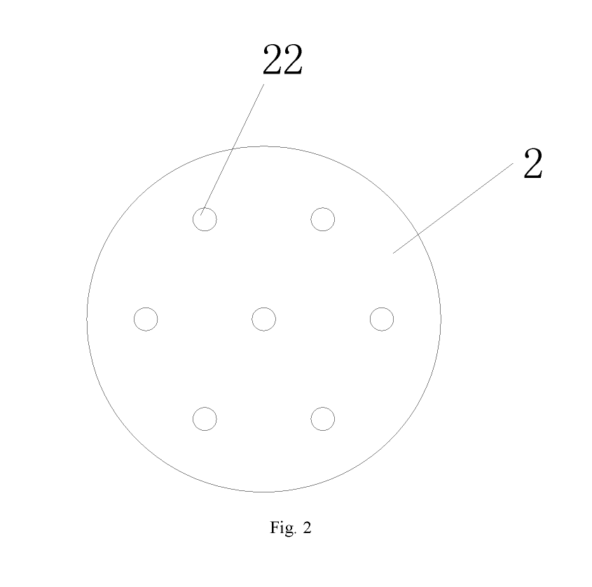

As shown in FIGS. 1 and 2, the present disclosure provides in embodiments a pneumatic sensor in an electronic cigarette. The pneumatic sensor in the electronic cigarette includes an electrode plate 1, a vibrating film unit, and a housing 2 sequentially arranged form up to down. The housing 2 defines a chamber and is provided with a window 23 at a top of the housing. The electrode plate 1 and the vibrating film unit are disposed inside the chamber through the window 23. The housing 2 is provided with an air inlet 21 at a side wall of the housing, and at least one suction hole 22 at a bottom of the housing. The window, the air inlet, and the suction hole all are communicated with the chamber.

The electrode plate 1 is positioned inside the housing 2 and provided with a wire 7 for outputting a signal at a top of the electrode plate 1, and acts as a signal outputting end of the pneumatic sensor in the electronic cigarette.

The vibrating film unit is disposed inside the housing 2 and provided with a vibrating film 6 capable of vibrating under airflow. The vibrating film 6 has a fixed end fixed to the vibrating film unit and a free end capable of vibrating up and down under airflow.

Further, the vibrating film unit includes an upper gasket 3, a supporting ring 5, and a lower gasket 4 disposed parallelly. The upper gasket 3 and the lower gasket 4 each are provided with an opening at a position corresponding to that of the air inlet. The vibrating film 6 is fixed to the supporting ring 5 at the fixed end. In a specific example, the fixed end is fixed at such a position of the supporting ring 5 that the fixed end corresponds to the openings of the upper gasket 3 and the lower gasket 4. The position of the fixed end of the vibrating film 6 corresponds to that of the air inlet 21 of the housing, which enables the vibrating film 6 to vibrate more sensitively under airflow when air enters from the air inlet.

Furthermore, the vibrating film 6 has a first side towards the bottom of the housing, and a second side towards the electrode plate 1. The vibrating film disposed on the supporting ring 5 is apart from the bottom of the housing and the electrode plate at a distance, respectively, due to certain thicknesses of both the upper gasket 3 and the lower gasket 4.

In an embodiment, the vibrating film 6 is in a trapezoidal shape with short and long edges, at either of which the vibrating film 6 is fixed to the supporting ring 5. In a specific example, the vibrating film 6 is fixed to the supporting ring 5 at the long edge. Such a configuration is beneficial to the vibration and allows for a more stable output signal. Further, depending on at which edge the vibrating film 6 is fixed to the supporting ring 5, the signal of the pneumatic sensor in the electronic cigarette can be adjusted accordingly. Certainly, the vibrating film 6 may also in other shapes, which is not limited herein.

Further, as shown in FIG. 1, the electrode plate 1 and the vibrating film unit are parallelly stacked inside the housing 2. In specific, the housing 2, the electrode plate 1, and the vibrating film unit are arranged concentrically, and an outer wall of the housing 2 is outside the electrode plate 1 and the vibrating film unit. The vibrating film unit is provided with an opening disposed at such a position corresponding to that of the air inlet of the housing 2.

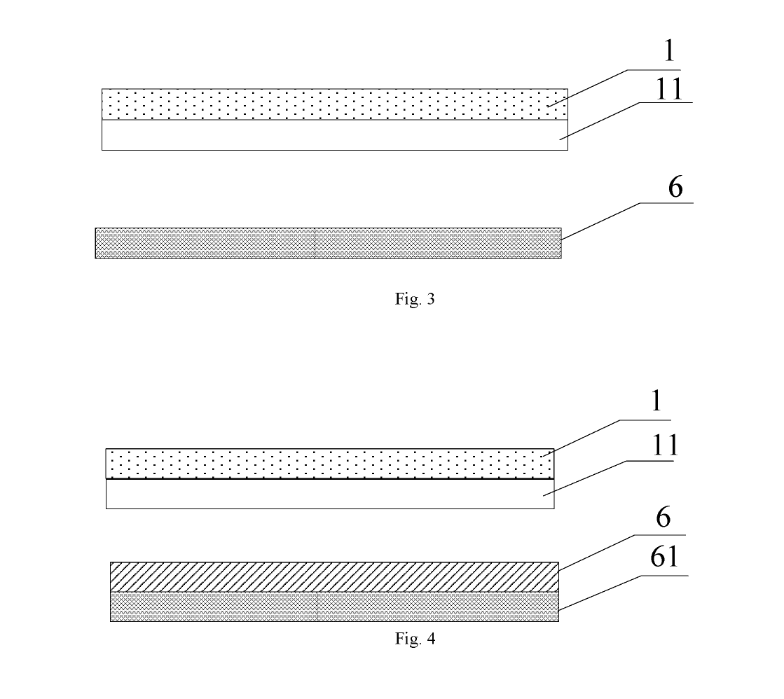

FIG. 3 is a schematic diagram showing a first triboelectric structure of a pneumatic sensor in an electronic cigarette in an embodiment of the present disclosure. As shown in FIGS. 1 and 3, in this embodiment, the electrode plate 1 and the housing 2 each acting as a signal outputting end, with the housing 2 being a negative electrode, are insulated from each other. Therefore, the free end of the vibrating film 6 is capable of being in contact with or separating from the electrode plate 1 as a result of deformation under airflow, such that a triboelectric interface is formed due to the contact between the free end of the vibrating film 6 and the electrode plate 1.

Airflow is formed in the chamber in case of air suction, under which the free end of the vibrating film is capable of deforming such that the free end is in contact with or separates from the electrode plate. Specifically, as the vibrating film is in the airflow field, airflow makes the free end of the vibrating film flutter up and down, thereby forming a triboelectric interface and thus generating electric charges due to triboelectric. It is possible to arrange the suction hole and the air inlet in different sizes and shapes as required in actual practice, respectively, as well as the number of the air inlets, all of which will not be particularly limited herein.

When air is sucked through the suction hole 22, airflow is formed in the chamber, which makes the free end of the vibrating film 6 deform. Besides, when airflow makes the free end of the vibrating film flutter up and down due to the vibrating film being in the airflow field, the vibrating film 6 comes into, from a separate state, a contact with the electrode plate 1, such that a triboelectric interface is formed between the vibrating film 6 and the electrode plate 1, thereby generating triboelectric charges and further resulting in a change of electric potential difference between the electrode plate 1 and the housing 2. Along with the changes in suction force, the free end of the vibrating film 6 is apart from the electrode plate 1 at different distances, or in contact with the electrode plate 1 with different contact areas, thereby generating different amounts of the triboelectric charges and thus resulting in different changes of electric potential difference between the electrode plate 1 and the housing 2. In addition, when the free end of the vibrating film 6 is back to an initial position due to disappearance of the suction force, the electric potential difference between the electrode plate 1 and the housing 2 is back to an initial state, such that an electrical signal is thus generated. At this time, the electrode plate 1 and the housing 2 each act as a signal outputting end of the pneumatic sensor in the electronic cigarette.

Alternatively, in this embodiment, the electrode plate 1 may be further provided with a first polymer layer 11 on a surface towards the vibrating film 6, such that a triboelectric interface is formed between the first polymer layer 11 and the vibrating film 6 based on a principle which will not be elaborated here.

Alternatively, in this embodiment, the housing 2 is further provided with a second polymer layer on an inner side of the bottom of the housing 2. The second polymer layer is disposed towards the vibrating film, such that a triboelectric interface is formed between the second polymer layer and the vibrating film 6. In addition, the second polymer layer is provided with at least one hole at a position corresponding to that of the suction hole 22 at the bottom of the housing, so as to facilitate the air suction.

The electrode plate described above may be made of a metal or conductive metal oxide. The vibrating film is a non-metallic vibrating film, and made of polyethylene plastic, polypropylene plastic, polyvinyl chloride, poly(perfluorinated ethylene-propylene), chlorosulfonated polyethylene, tetrafluoroethylene-ethyl ene copolymer, polytrifluorochloroethylene, polytetrafluoroethylene, polyvinylidene fluoride, polystyrene, chlorinated polyether, polyphenylene sulfide, ethylene-vinyl acetate copolymer, polyimide film, aniline formaldehyde resin film, polyformaldehyde film, ethylcellulose film, polyamide film, melamine formaldehyde film, polyethylene glycol succinate film, cellulose film, cellulose acetate film, polyethylene glycol adipate film, poly(diallyl phthalate) film, fiber (regeneration) sponge film, polyurethane elastomer film, styrene-propylene copolymer film, styrene-butadiene copolymer film, artificial fiber film, polymethylmethacrylate film, polyvinyl alcohol film, polyisobutylene film, polyethylene terephthalate film, polyvinyl butyral film, formaldehyde phenol condensation polymer film, chloroprene rubber film, butadiene propylene copolymer film, natural rubber film, butyl rubber film, butyronitrile rubber film, hydrogenated butyronitrile film, polyacrylonitrile film, acrylonitrile vinyl chloride copolymer film, silicon rubber film, ethylene propylene terpolymer (EPDM) film, butadiene styrene rubber film, isoprene rubber film, cis-polybutadiene rubber film or fluorine rubber film.

The first polymer layer and the second polymer layer each may be made of polyethylene plastic, polypropylene plastic, polyvinyl chloride, poly(perfluorinated ethylene-propylene), chlorosulfonated polyethylene, tetrafluoroethylene-ethylene copolymer, polytrifluorochloroethylene, polytetrafluoroethylene, polyvinylidene fluoride, polystyrene, chlorinated polyether, polyphenylene sulfide, ethylene-vinyl acetate copolymer, polyimide film, aniline formaldehyde resin film, polyformaldehyde film, ethylcellulose film, polyamide film, melamine formaldehyde film, polyethylene glycol succinate film, cellulose film, cellulose acetate film, polyethylene glycol adipate film, poly(diallyl phthalate) film, fiber (regeneration) sponge film, polyurethane elastomer film, styrene-propylene copolymer film, styrene-butadiene copolymer film, artificial fiber film, polymethylmethacrylate film, polyvinyl alcohol film, polyisobutylene film, polyethylene terephthalate film, polyvinyl butyral film, formaldehyde phenol condensation polymer film, chloroprene rubber film, butadiene propylene copolymer film, natural rubber film, butyl rubber film, butyronitrile rubber film, hydrogenated butyronitrile film, polyacrylonitrile film, acrylonitrile vinyl chloride copolymer film, silicon rubber film, ethylene propylene terpolymer (EPDM) film, butadiene styrene rubber film, isoprene rubber film, cis-polybutadiene rubber film or fluorine rubber film.

Alternatively, the vibrating film is made of polyvinylidene fluoride (PVDF), and the first polymer layer and the second polymer layer each are made of polyethylene terephthalate (PET).

The first polymer layer 11 and the vibrating film 6 each are made of such the respective indicated material that the material of the first polymer layer 11 has electrostatic series arranged differently from that of the vibrating film 6 when a triboelectric is generated between the first polymer layer 11 and the vibrating film 6.

In addition, the electrode plate 1 and the vibrating film 6 each are made of such the respective indicated material that the material of the electrode plate 1 has electrostatic series arranged differently from that of the vibrating film 6 when a triboelectric is generated between the electrode plate 1 and the vibrating film 6.

FIG. 4 is schematic diagram showing a second triboelectric structure of a pneumatic sensor in an electronic cigarette in an embodiment of the present disclosure. As shown in FIG. 4, in this embodiment, the vibrating film 6 is further provided with a flexible electrode layer 61 on a surface away from the electrode plate 1, and the electrode plate 1 and the flexible electrode layer 61 each act as a signal outputting end of the pneumatic sensor in the electronic cigarette. The flexible electrode layer may be made of a metal or conductive metal oxide. It should be noted that, the flexible electrode layer is processed onto the vibrating film by a technology known to those skilled in the art, such as magnetron sputtering technology, without affecting deformable ability of the vibrating film. Meanwhile, in this embodiment, the housing 2 may act as a shield layer individually to shield an external interference signal.

When air is sucked through the suction hole 22, airflow is formed in the chamber, which makes the free end of the vibrating film 6 deform. Besides, when airflow makes the free end of the vibrating film flutter up and down due to the vibrating film being in the airflow field, the vibrating film 6 comes into, from a separate state, a contact with the electrode plate 1, such that a triboelectric interface is formed between the vibrating film 6 and the electrode plate 1, thereby generating triboelectric charges and further resulting in a change of electric potential difference between the electrode plate 1 and the flexible electrode layer on the vibrating film 6. Along with the changes in suction force, the free end of the vibrating film 6 is apart from the electrode plate 1 at different distances, or in contact with the electrode plate 1 with different contact areas, thereby generating different amounts of the triboelectric charges and thus resulting in different changes of electric potential difference between the electrode plate 1 and the flexible electrode layer on the vibrating film 6. In addition, when the free end of the vibrating film 6 is back to an initial position due to disappearance of the suction force, the electric potential difference between the electrode plate 1 and the flexible electrode layer is back to an initial state, such that an electrical signal is thus generated. At this case, between the electrode plate 1 and the flexible electrode layer each act as a signal outputting end of the pneumatic sensor in the electronic cigarette.

Alternatively, in this embodiment, the electrode plate 1 may be further provided with a first polymer layer 11 on a surface towards the vibrating film 6, such that a triboelectric interface is formed between the first polymer layer 11 and the vibrating film 6 based on a principle which will not be elaborated here.

Alternatively, in this embodiment, the housing 2 is further provided with a second polymer layer on an inner side of the bottom of the housing 2. The second polymer layer is disposed towards the vibrating film 6, such that a triboelectric interface is formed between the second polymer layer and the vibrating film 6. In addition, the second polymer layer is provided with at least one hole at a position corresponding to that of the suction hole 22 at the bottom of the housing, so as to facilitate the air suction.

With respect to selection of the material in the present embodiment, reference can be made to above-described in first embodiment.

The present disclosure further provides in embodiments a device for processing airflow. The device for processing airflow includes: the pneumatic sensor in the electronic cigarette described above and a signal processing system. The pneumatic sensor in the electronic cigarette is configured to sense airflow passing through and output a sensing signal. The signal processing system is configured to receive and process the sensing signal, and output a controlling signal.

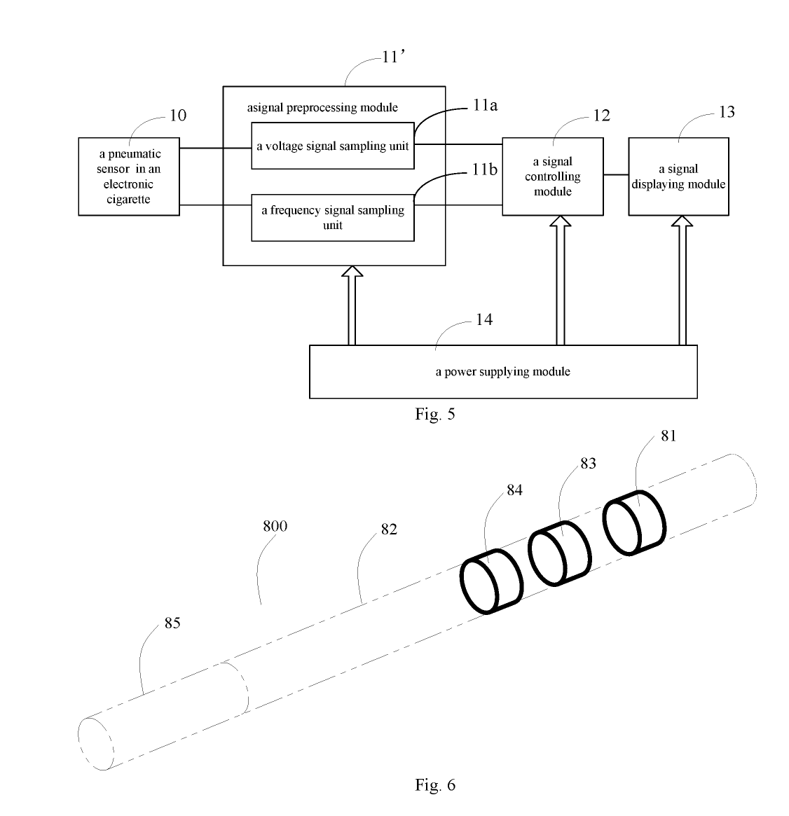

FIG. 5 is block diagram showing a function of a signal processing system included in a device for processing airflow in an embodiment of the present disclosure. As shown in FIG. 5, the signal processing system includes: a signal preprocessing module 11′ and a signal controlling module 12.

The signal preprocessing module 11′ is connected to an electrical signal outputting end of the pneumatic sensor 10 in the electronic cigarette, and configured to collect an output signal of the pneumatic sensor 10 in the electronic cigarette and acquire a flag signal through comparing the output signal with a preset threshold. The signal preprocessing module 11′ samples the output signal based on a characteristic of the output signal of the pneumatic sensor 10 in the electronic cigarette. The pneumatic sensor in the electronic cigarette generally outputs a signal with low current and high voltage, therefore sampling may be performed based on a voltage signal.

Specifically, the signal preprocessing module 11′ includes a voltage signal sampling unit 11a, which is configured to collect the output signal of the pneumatic sensor 1 in the electronic cigarette; and compare a voltage of the output signal with a preset voltage threshold to acquire a low level flag signal in the case that the voltage of the output signal is lower than the preset voltage threshold, otherwise a high level flag signal in the case of the voltage of the output signal is higher than or equal to the preset voltage threshold. For example, the preset voltage threshold is set to 100 mV. In the case that the voltage of the output signal is lower than 100 mV, the low level flag signal is output. In the case that the voltage of the output signal is higher than or equal to 100 mV, then a high level flag signal is output.

Alternatively, the output signal may also be sampled by a frequency selection. In specific, the signal preprocessing module 11′ may include a frequency signal sampling unit 11b, which is configured to collect the output signal of the pneumatic sensor 10 in the electronic cigarette; and compare a frequency of the output signal with a preset frequency range to acquire a high level flag signal in the case that the frequency of the output signal falls into the preset frequency range, otherwise a low level flag signal in the case that the frequency of the output signal is not within the preset frequency range.

For further improving accuracy and stability of the signal processing system, voltage sampling and frequency sampling may be performed at the same time. That is, the signal preprocessing module 11′ may include both the voltage signal sampling unit 11a configured to compare the voltage of the output signal with the preset voltage threshold and the frequency signal sampling unit 11b configured to compare the frequency of the output signal with the preset frequency range. The high level flag signal is acquired in the case that the voltage of the output signal is higher than or equal to the preset voltage threshold and the frequency of the output signal falls into the preset frequency range; otherwise the low level flag signal is acquired in the case that the voltage of the output signal is lower than the preset voltage threshold and/or the frequency of the output signal is not within the preset frequency range. In specific, the low level flag signal is acquired in each of the following cases that the voltage of the output signal is lower than the preset voltage threshold and the frequency of the output signal falls into the preset frequency range; the voltage of the output signal is higher than or equal to the preset voltage threshold and the frequency of the output signal is not within the preset frequency range; or the voltage of the output signal is lower than the preset voltage threshold and the frequency of the output signal is not within the preset frequency range. Simultaneously performing the voltage sampling and frequency sampling allows for increased accuracy, lowered false alarming rate and thus improved stability for the whole signal processing system.

The signal controlling module 12 is configured to receive the flag signal output from the signal preprocessing module 11′ and to acquire a work trigging signal through analyzing and processing the flag signal. In embodiments of the present disclosure, the signal controlling module 12 is configured to acquire the work trigging signal in accordance with the flag signal analyzed and processed to be the high level flag signal. Such a work trigging signal is configured to trigger a subsequent work process. Taking the electronic cigarette as an example, the work trigging signal output from the signal controlling module 12 is configured to trigger an atomizer of the electronic cigarette to work such that tobacco tar nearby is volatilized to generate smoke, which is supplied to the user for smoking.

Further, for improving accuracy and stability of the signal processing system, the work trigging signal is acquired further based on duration of the high level flag signal when it is determined as the flag signal. In the case that the duration of the high level flag signal is too short, such as instantaneous high level, it is not necessary to output the trigger signal.

The signal processing system described above may further include: a signal displaying module 13 connected to the signal controlling module 12, and configured to display a working state of the pneumatic sensor in the electronic cigarette according to the work trigging signal. The signal displaying module 13 may be a light emitting diode (LED) lamp or a display screen. When the pneumatic sensor in the electronic cigarette outputs different values of signals, the signal displaying module 13 may display and directly feedback the working state to the user according to an analysis result of the signal controlling module 12. In addition, the signal displaying module 13 may also display which sampling mode is applied to the output signal, a voltage sampling mode, a frequency sampling mode, or a voltage and frequency sampling mode.

The signal processing system described above may further include: a power supplying module 14 configured to supply power to the signal preprocessing module 11′, the signal controlling module 12, and the signal displaying module 13. The power supplying module 14 may be a lithium battery, or a chargeable module which can be charged in a manner, such as USB or Bluetooth.

Above modules for collecting, analyzing and processing the signal may be integrated into a one-chip structure or discrete structures according to an integrated mode of the power supplying module.

The one-chip structure applies a chip based on an application specific integrated circuit (ASIC) technology for integrating the signal preprocessing module, the signal controlling module, the signal displaying module, and the power supplying module into one chip. Compared with a common integrated circuit, the one-chip structure has advantages such as a smaller volume, lighter weight, lower power consumption, improved reliability and performance, enhanced security, and lower costs.

The discrete structures achieve the collection, analysis and process of the signal by one chip microcomputer (i.e. the signal preprocessing module and the signal controlling module are integrated into the one chip microcomputer) and achieve the whole signal processing system by combining an additional power supplying module.

The signal processing system described above makes the work triggering signal output more accurate and stable by collecting, analyzing and processing the signal with a low value output from the pneumatic sensor in the electronic cigarette.

FIG. 6 is a structural schematic diagram showing an electronic cigarette in an embodiment of the present disclosure. As shown in FIG. 6, the electronic cigarette 800 includes: a device 81 for processing airflow described above, a rod 82, an atomizer 84, and a power device 83.

In specific, the power device 83 supplies power to the atomizer 84 and the device 81 for processing airflow. The device 81 for processing airflow is connected to the atomizer 84. The electronic cigarette 800 is provided with an air inlet (not shown in figures) and a cigarette holder 85. The device 81 for processing airflow is inside a smoke channel which is communicated with the air inlet and the cigarette holder 85 of the electronic cigarette 800. When the user sucks the electronic cigarette through the cigarette holder 85, airflow enters the device 81 for processing airflow through the air inlet of the electronic cigarette 800, such that a triboelectric interface is formed in an internal structure of the pneumatic sensor in the electronic cigarette, triboelectric charges are then generated, and thus an electrical signal is formed by the pneumatic sensor in the electronic cigarette. The device 81 for processing airflow outputs a controlling signal based on the electrical signal to control the atomizer 84 to work such that tobacco tar nearby is volatilized to generate smoke, which is supplied to the user for smoking through the smoke channel.

The pneumatic sensor in the electronic cigarette provided in embodiments of the present disclosure has advantages such as low production costs and low requirement to an external signal processing circuit. Meanwhile, in the case that external vibration is not sufficient to enable the triboelectric interface of the pneumatic sensor in the electronic cigarette to generate a significant electrical signal, the pneumatic sensor in the electronic cigarette is capable of easily distinguishing an electrical signal generated under airflow from that generated under vibration interference through designing the signal processing circuit, because a voltage signal with a high value is generated under airflow passing through, thereby effectively preventing the false trigger due to the vibration interference and improving the stability of the pneumatic sensor in electronic cigarette. In addition, the present disclosure further provides in embodiments a device for processing airflow which includes the pneumatic sensor in the electronic cigarette described above and a signal processing system, which is applied to the electronic cigarette, thereby effectively reducing production costs of the electronic cigarette, simplifying the process for manufacturing the electronic cigarette, effectively preventing the false trigger due to the vibration interference, and improving the stability of the electronic cigarette.

It could be appreciated that, the present disclosure is described through some embodiments. It is known to those skilled in the art that, various changes or equivalent alternatives can be made to these characteristics and embodiments without departing from spirit and scope of the present disclosure. In addition, modifications made to these characteristics and embodiments under teaching of the present disclosure to adapt to specific circumstances and materials will not depart from spirit and scope of the present disclosure. Therefore, specific embodiments disclosed herein cannot be construed to limit the present disclosure, and all embodiments within the scope of claims fall into the claimed scope of the present disclosure.

What is claimed is:

1. A pneumatic sensor in an electronic cigarette, comprising:
a housing, defining a chamber and provided with a window at a top of the housing, an air inlet at a side wall of the housing, and at least one suction hole at a bottom of the housing, the window, the air inlet, and the suction hole all being communicated with the chamber;
a vibrating film unit, disposed inside the housing and provided with a vibrating film capable of vibrating under airflow; and
an electrode plate, acting as a signal outputting end of the pneumatic sensor in the electronic cigarette,
wherein the vibrating film has a fixed end fixed to the vibrating film unit and a free end.

2. The pneumatic sensor in the electronic cigarette according to claim 1, wherein the vibrating film unit also comprises an upper gasket, a supporting ring, and a lower gasket disposed in parallel, both the upper gasket and the lower gasket are provided with an opening at a position corresponding to that of the air inlet, the fixed end of the vibrating film is fixedly disposed at such a position of the supporting ring that the fixed end corresponds to the openings of the upper gasket and the lower gasket.

3. The pneumatic sensor in the electronic cigarette according to claim 2, wherein the vibrating film is in a trapezoidal shape with a short edge fixed to the supporting ring.

4. The pneumatic sensor in the electronic cigarette according to claim 2, wherein the vibrating film is in a trapezoidal shape with a long edge fixed to the supporting ring.

5. The pneumatic sensor in the electronic cigarette according to claim 2, wherein the free end of the vibrating film is capable of being in contact with or separated from the electrode plate as a result of deformation under airflow, such that a triboelectric interface is formed due to the contact between the free end of the vibrating film and the electrode plate.

6. The pneumatic sensor in the electronic cigarette according to claim 5, wherein the vibrating film has a first side towards the bottom of the housing, and a second side towards the electrode plate, and the vibrating film is apart from the bottom of the housing and the electrode plate at a distance, respectively.

7. The pneumatic sensor in the electronic cigarette according to claim 5, wherein the electrode plate is made of a material with electrostatic series arranged differently from that of the vibrating film.

8. The pneumatic sensor in the electronic cigarette according to claim 5, wherein the electrode plate is further provided with a first polymer layer on a surface towards the vibrating film, and the free end of the vibrating film is capable of being in contact with or separated from the first polymer layer as a result of deformation under airflow, such that a triboelectric interface is formed due to the contact between the free end of the vibrating film and the first polymer layer.

9. The pneumatic sensor in the electronic cigarette according to claim 8, wherein the first polymer layer is made of a material with electrostatic series arranged differently from that of the vibrating film.

10. The pneumatic sensor in the electronic cigarette according to claim 5, wherein the housing is provided with a second polymer layer on the bottom of the housing towards the vibrating film, the second polymer layer is provided with at least one hole at a position corresponding to that of the suction hole at the bottom of the housing, and the free end of the vibrating film is capable of being in contact with or separated from the second polymer layer as a result of deformation under airflow, such that a triboelectric interface is formed due to the contact between the free end of the vibrating film and the second polymer layer.

11. The pneumatic sensor in the electronic cigarette according to claim 10, wherein the second polymer layer is made of a material with electrostatic series arranged differently from that of the vibrating film.

12. The pneumatic sensor in the electronic cigarette according to claim 5, wherein the electrode plate and the housing are in an insulation connection and are two signal outputting ends of the pneumatic sensor in the electronic cigarette.

13. The pneumatic sensor in the electronic cigarette according to claim 5, wherein the vibrating film is further provided with a flexible electrode layer on a surface away from the electrode plate; and the electrode plate and the flexible electrode layer are two signal outputting ends of the pneumatic sensor in the electronic cigarette.

14. The pneumatic sensor in the electronic cigarette according to claim 1, wherein the electrode plate is made of a metal or conductive metal oxide.

15. The pneumatic sensor in the electronic cigarette according to claim 1, wherein the vibrating film is made of polyethylene plastic, polypropylene plastic, polyvinyl chloride, poly(perfluorinated ethylene-propylene), chlorosulfonated polyethylene, tetrafluoroethylene-ethylene copolymer, polytrifluorochloroethylene, polytetrafluoroethylene, polyvinylidene fluoride, polystyrene, chlorinated polyether, polyphenylene sulfide, ethylene-vinyl acetate copolymer, polyimide film, aniline formaldehyde resin film, polyformaldehyde film, ethylcellulose film, polyamide film, melamine formaldehyde film, polyethylene glycol succinate film, cellulose film, cellulose acetate film, polyethylene glycol adipate film, poly(diallyl phthalate) film, fiber regeneration sponge film, polyurethane elastomer film, styrene-propylene copolymer film, styrene-butadiene copolymer film, artificial fiber film, polymethylmethacrylate film, polyvinyl alcohol film, polyisobutylene film, polyethylene terephthalate film, polyvinyl butyral film, formaldehyde phenol condensation polymer film, chloroprene rubber film, butadiene propylene copolymer film, natural rubber film, butyl rubber film, butyronitrile rubber film, hydrogenated butyronitrile film, polyacrylonitrile film, acrylonitrile vinyl chloride copolymer film, silicon rubber film, ethylene propylene terpolymer (EPDM) film, butadiene styrene rubber film, isoprene rubber film, cis-polybutadiene rubber film or fluorine rubber film.

16. The pneumatic sensor in the electronic cigarette according to claim 8, wherein the first polymer layer and the second polymer layer each are made of polyethylene plastic, polypropylene plastic, polyvinyl chloride, poly(perfluorinated ethylene-propylene), chlorosulfonated polyethylene, tetrafluoroethylene-ethylene copolymer, polytrifluorochloroethylene, polytetrafluoroethylene, polyvinylidene fluoride, polystyrene, chlorinated polyether, polyphenylene sulfide, ethylene-vinyl acetate copolymer, polyimide film, aniline formaldehyde resin film, polyformaldehyde film, ethylcellulose film, polyamide film, melamine formaldehyde film, polyethylene glycol succinate film, cellulose film, cellulose acetate film, polyethylene glycol adipate film, poly(diallyl phthalate) film, fiber regeneration sponge film, polyurethane elastomer film, styrene-propylene copolymer film, styrene-butadiene copolymer film, artificial fiber film, polymethylmethacrylate film, polyvinyl alcohol film, polyisobutylene film, polyethylene terephthalate film, polyvinyl butyral film, formaldehyde phenol condensation polymer film, chloroprene rubber film, butadiene propylene copolymer film, natural rubber film, butyl rubber film, butyronitrile rubber film, hydrogenated butyronitrile film, polyacrylonitrile film, acrylonitrile vinyl chloride copolymer film, silicon rubber film, ethylene propylene terpolymer (EPDM) film, butadiene styrene rubber film, isoprene rubber film, cis-polybutadiene rubber film or fluorine rubber film.

17. The pneumatic sensor in the electronic cigarette according to claim 13, wherein the flexible electrode layer is made of a metal or conductive metal oxide.

18. A device for processing airflow, comprising a pneumatic sensor in the electronic cigarette according to claim 1, and a signal processing system, wherein the signal processing system comprises:
a signal preprocessing module connected to a signal outputting end of the pneumatic sensor in the electronic cigarette, and configured to collect an output signal of the pneumatic sensor in the electronic cigarette and acquire a flag signal through comparing the output signal with a preset threshold; and
a signal controlling module connected to the signal preprocessing module, and configured to receive the flag signal output from the signal preprocessing module and acquire a work trigging signal through analyzing and processing the flag signal.

19. The device according to claim 18, wherein the signal preprocessing module comprises: a voltage signal sampling unit configured to
collect the output signal of the pneumatic sensor in the electronic cigarette; and
compare a voltage of the output signal with a preset voltage threshold to acquire a low level flag signal in the case that the voltage of the output signal is lower than the preset voltage threshold, otherwise a high level flag signal in the case of the voltage of the output signal is higher than or equal to the preset voltage threshold.

20. The device according to claim 18, wherein the signal preprocessing module comprises: a frequency signal sampling unit configured to
collect the output signal of the pneumatic sensor in the electronic cigarette; and
compare a frequency of the output signal with a preset frequency range to acquire a low level flag signal in the case that the frequency of the output signal is not within the preset frequency range, otherwise a high level flag signal in the case that the frequency of the output signal falls into the preset frequency range.

21. The device according to claim 18, wherein the signal preprocessing module comprises: a voltage signal sampling unit configured to compare a voltage of the output signal with a preset voltage threshold, and a frequency signal sampling unit configured to compare a frequency of the output signal with a preset frequency range;
a high level flag signal is acquired, in the case that the voltage of the output signal is higher than or equal to the preset voltage threshold and the frequency of the output signal falls into the preset frequency range;
a low level flag signal is acquired, in the case that the voltage of the output signal is lower than the preset voltage threshold and/or the frequency of the output signal is not within the preset frequency range.

22. The device according to claim 19, wherein the signal controlling module is configured to acquire the work trigging signal based on duration of the high level flag signal when it is determined as the flag signal.

23. The device according to claim 18, further comprising:
a signal displaying module connected to the signal controlling module, and configured to display a working state of the pneumatic sensor in the electronic cigarette according to the work trigging signal.

24. The device according to claim 22, further comprising:
a signal displaying module connected to the signal controlling module, and configured to display a working state of the pneumatic sensor in the electronic cigarette according to the work trigging signal.

25. The device according to claim 18, further comprising:
a power supplying module configured to supply power to the signal preprocessing module and the signal controlling module.

26. The device according to claim 25, wherein the power supplying module, the signal preprocessing module, and the signal controlling module are integrated into a one-chip structure or discrete structures.

27. An electronic cigarette, comprising: a device for processing airflow according to claim 18, a rod, an atomizer, and a power device.
